(19) United States
(12) Patent Application Publication
(10) Pub. No.: US 2018/0218796 A1
(43) Pub. Date: Aug. 2, 2018

(54) HYBRID SAFETY INJECTION TANK SYSTEM PRESSURIZED WITH SAFETY VALVE OF PRESSURIZER

(71) Applicant: Korea Atomic Energy Research Institute, Daejeon (KR)

(72) Inventors: Tae-Soon Kwon, Daejeon (KR); Kihwan Kim, Daejeon (KR); Chul-Hwa Song, Daejeon (KR); Joon-Eon Yang, Daejeon (KR); Won Pil Baek, Daejeon (KR)

(73) Assignee: Korea Atomic Energy Research Institute, Daejeon (KR)

(21) Appl. No.: 13/893,833

(22) Filed: May 14, 2013

(30) Foreign Application Priority Data
Aug. 3, 2012 (KR) 10-2012-0085108

(51) Int. Cl. G21C 15/18; G21D 3/06; G21C 15/12; G21C 19/04; G21D 1/02

(52) U.S. Cl. CPC G21C 15/18; G21D 3/06; G21C 15/12; G21C 19/04; G21Y 2004/40; G21Y 2002/207; G21Y 2002/50; G21Y 2004/302; G21D 1/02

(57) ABSTRACT

A hybrid safety injection tank system. The system is pressurized with a safety valve of a pressurizer, which functions as a low pressure safety injection tank and as a high pressure core makeup tank of a nuclear reactor emergency core cooling system. The safety valve is configured to be automatically operated in response to a pressure difference and is installed on a pressure equalization pipe that can realize pressure equalization between the low pressure safety injection tank and the high pressure pressurizer in the event of the nuclear power plant station blackout and power outage.

### CROSS-REFERENCES TO RELATED APPLICATION

This patent application claims the benefit of priority from Korean Patent Application No. 10-2012-0085108, filed on Aug. 3, 2012, the contents of which are incorporated herein by reference.

### BACKGROUND OF THE INVENTION

### Field of the Invention

The present invention relates, in general, to a hybrid safety injection tank system that has the functions of a low pressure safety injection tank and as a high pressure core makeup tank of a nuclear reactor emergency core cooling system, and, more particularly, to a hybrid safety injection tank system pressurized with a safety valve of a pressurizer, which is operated using the safety valve that is configured in such a way that it can be automatically opened in response to a pressure difference without using electric power, in addition to a conventional motorized isolation valve, when pressurizing a hybrid safety injection tank in a low pressure state using high pressure steam of a pressurizer, thereby realizing an efficient operation even in the event of a nuclear power plant station blackout and reducing the probability of core damage.

### Description of the Related Art

Generally, a safety injection system for a nuclear power plant is intended to supply cooling water to a core in the event of a loss of coolant accident (LOCA) of a nuclear reactor so as to remove a residual heat from the core and to maintain a geometrical shape of the core, thereby enabling the long-term cooling of the core. Further, the safety injection system is configured such that, when a large-scale loss of coolant accident occurs, sufficient emergency core cooling water is supplied by a safety injection tank (or pressure accumulator) until a refill phase, and the cooling water is supplied by low pressure safety injection pumps in a reflooding period.

Further, examples of conventional safety injection tank systems of a nuclear reactor emergency core cooling system are an AP600 core makeup tank (CMT) that is shown in FIG. 1 and is disclosed in U.S. Pat. No. 5,268,943 and in “Nuclear Engineering and Design” Vol. 186, p 279˜301, or a CARR (CP1300) core makeup tank that is developed by CARR (Center for Advanced Reactor Research) and is disclosed in NUREG-IA-0134.

Described in detail, the AP600 core makeup tank and the CARR (CP1300) core makeup tank are pressurized with the pressure of a high pressure reactor cooling system (RCS) or pressurizer to be applied to the nuclear reactor makeup under the condition that the nuclear reactor system has a high pressure accident, and the safety injection tank is applied to the emergency core cooling water injection when the nuclear reactor has a low pressure accident. However, such a configuration has a drawback in that, when the nuclear reactor has a low pressure accident, an injection capacity of only the core makeup tank is not sufficient compared to a capacity required for the nuclear reactor safety. By contrast, when the nuclear reactor system has a high pressure accident, it is impossible to inject the emergency core cooling water of low pressure safety injection tank into the nuclear reactor system due to a counterpressure difference.

In an effort to solve the problems, for example, those found in the “Passive High pressure Safety Injection Tank System for Handling SBO and LOCA” disclosed in Korean Patent No. 10-1071415 (registered on Sep. 30, 2011), there has been proposed a hybrid safety injection tank that is operable under low pressure and high pressure, respectively, as shown in FIG. 2. In this safety injection tank system, the function of a conventional low pressure safety injection tank (SIT) and the function of a conventional high pressure core makeup tank (CMT) are integrated with each other. Further, a motorized valve or a pneumatic valve is installed on a pressure equalization pipe that is used to realize pressure equalization between the low pressure safety injection tank and a high pressure pressurizer of this safety injection tank system, such that the valve can be used when necessary. Due to the motorized valve or the pneumatic valve, it is required to necessarily install an additional dedicated battery in this safety injection tank system so as to guarantee operation for at least 36 hours to 72 hours or more in the event of a nuclear power plant station blackout.

However, the safety injection tank system disclosed in Korean Patent No. 10-1071415 is problematic in that, in addition to the first inconvenience, that the tank system should use the additional dedicated battery guaranteeing efficient operation for a lengthy period of time, even in a heavy-use environment, the battery should be always maintained and managed so it is in an available state and can guard against unexpected emergencies, thus causing a secondary inconvenience.

Further, in an effort to prevent incorrect operation of the nuclear reactor system and to secure a reliable operation in the event of emergencies, it is preferred that the nuclear reactor system be configured to be operated in a completely passive state without being driven by a separate electric power source or by a pneumatic device. Particularly, after the Fukushima Daiichi nuclear disaster that occurred in Japan 2011, the need for and importance of a passive safety system that can be operated even in the event of nuclear power plant station blackout has been emphasized.

Accordingly, in order to solve the problems experienced in the related art techniques, it is preferred to provide a hybrid safety injection tank system which has the function of a low pressure safety injection tank and the function of a high pressure core makeup tank, and in which a safety valve can be automatically opened or closed in response to a pressure difference without using either electric power or compressed gas, and so the safety valve can be reliably and efficiently operated even during a nuclear power plant station blackout. However, neither a device nor a method that can satisfy the above-mentioned requirements has thus far been proposed or provided.

### SUMMARY OF THE INVENTION

Accordingly, the present invention has been made keeping in mind the above problems occurring in the related art, and the present invention is intended to propose a hybrid safety injection tank system which has the function of a low pressure safety injection tank and the function of a high pressure core makeup tank, and in which, in addition to a motorized pressure equalization pipe isolation valve of a conventional hybrid safety injection tank system, a safety valve that can be automatically opened or closed in response to a pressure difference without using either electric power or compressed gas is used, and so the safety valve can be reliably and efficiently operated even in the event of a nuclear power plant station blackout.

In order to achieve the above object, according to an aspect of the present invention, there is provided a hybrid safety injection tank system pressurized with a safety valve of a pressurizer, comprising: an emergency core cooling water safety injection tank (SIT) charged both with cooling water and with nitrogen gas for cooling a nuclear reactor system; a pressurizer for supplying high pressure steam to the safety injection tank; a pressure equalization pipe connecting the safety injection tank to the pressurizer so as to realize pressure equalization between the safety injection tank and the pressurizer; a pressure equalization pipe isolation valve installed on the pressure equalization pipe so as to isolate the safety injection tank from the pressurizer; a pressure equalization pipe check valve installed on the pressure equalization pipe in series with the pressure equalization pipe isolation valve so as to prevent a backflow from the safety injection tank to the pressurizer; and a safety valve installed on the pressure equalization pipe in parallel both with the pressure equalization pipe isolation valve and with the pressure equalization pipe check valve so as to isolate the safety injection tank from the pressurizer.

The hybrid safety injection tank system may further include: an emergency core cooling water injection pipe connecting the safety injection tank to the nuclear reactor system; a safety injection tank (SIT) isolation valve installed on the emergency core cooling water injection pipe so as to isolate the safety injection tank from the nuclear reactor system; and a cooling water check valve installed on the emergency core cooling water injection pipe in series with the safety injection tank isolation valve so as to prevent a backflow from the nuclear reactor system to the safety injection tank.

In the hybrid safety injection tank system, the safety valve may be a valve configured in such a way that the safety valve is automatically opened or closed in response to a pressure difference so as to be operated even in a nuclear power plant station blackout.

Further, the safety valve may be configured in such a way that the safety valve is opened when a pressure difference between the safety injection tank and the pressurizer exceeds a predetermined reference value.

Further, each of the pressure equalization pipe isolation valve and the safety injection tank isolation valve may be a valve that can be opened or closed by a remote manipulation of a pilot or by a control signal of a nuclear reactor control system.

Further, each of the pressure equalization pipe isolation valve and the safety injection tank isolation valve may be a motorized valve or a POSRV (pilot operated safety and relief valve) that can be opened or closed by a pilot.

As described above, in the hybrid safety injection tank system pressurized with the safety valve of the pressurizer according to the present invention, the safety valve that is mounted to the pressurizer is connected to the pressure equalization pipe, and so, when the low pressure safety injection tank is pressurized to a high pressure using the steam of the pressurizer, it is not required to separately control an on/off valve of the pressure equalization pipe, and the operation of the on/off valve can be performed without using electric power or a control signal, and so the hybrid safety injection tank system can be reliably and efficiently operated even in the event of a nuclear power plant station blackout.

Accordingly, as described above, the hybrid safety injection tank system pressurized with the safety valve of the pressurizer according to the present invention uses neither electric power nor a control signal, and so the hybrid safety injection tank system does not require or use an additional dedicated battery that is configured to guarantee operation for at least 36 hours to 72 hours or more in the event of a nuclear power plant station blackout.

Further, as described above, the hybrid safety injection tank system pressurized with the safety valve of the pressurizer according to the present invention uses neither electric power nor a control signal, and so, in the event of a small steam line break, the shutoff valve that is installed in a parallel state can be operated in response to a control signal of a nuclear reactor protective system or can be opened or closed by a remote manipulation of a pilot.

Further, as described above, the hybrid safety injection tank system pressurized with the safety valve of the pressurizer according to the present invention uses neither electric power nor a control signal, and so the hybrid safety injection tank system can be efficiently operated even in the event of a nuclear power plant station blackout, thereby remarkably improving the emergency core cooling capacity of the high pressure nuclear reactor system and realizing the safety operation of the nuclear reactor.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a view schematically illustrating the construction of a conventional core makeup tank;

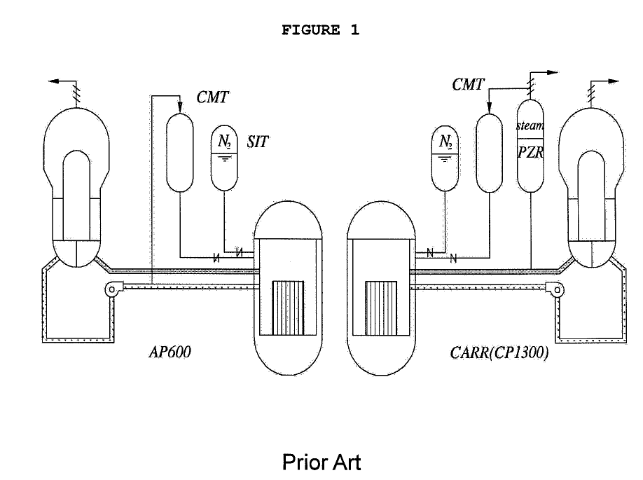

FIG. 2 is a view schematically illustrating the construction of a conventional hybrid safety injection tank system; and

FIG. 3 is a view schematically illustrating the construction of a hybrid safety injection tank system according to an embodiment of the present invention.

### DETAILED DESCRIPTION OF THE INVENTION

Hereinbelow, a preferred embodiment of a hybrid safety injection tank system (Hybrid SIT) pressurized with a safety valve according to the present invention will be described in detail with reference to the accompanying drawings.

Here, it should be understood that the embodiment of the present invention may be changed to a variety of embodiments and the scope and spirit of the present invention are not limited to the embodiment described hereinbelow. The embodiment of the present invention described hereinbelow is provided for allowing those skilled in the art to more clearly comprehend the present invention.

That is, as described later herein, the present invention provides a hybrid safety injection tank system, in which a pressure equalization pipe is formed by arranging a pressure equalization pipe of a conventional hybrid safety injection tank system in a parallel state and by combining a safety valve that can be operated even in the event of a nuclear power plant station blackout with a shutoff valve that can be operated in response to a manipulation signal input by a pilot.

Here, as described later herein, the safety valve is preset based on a preset pressure of a pressurizer safety valve, and the shutoff valve that can be controlled by the pilot may use a POSRV (Pilot Operated Safety and Relief Valve) that is configured to be controlled by a motorized valve or by a pilot.

Further, the shutoff valve is dualized in such a way that the shutoff valve can be manually opened or closed by a remote manipulation of a pilot or can be automatically opened or closed in response to a control signal of a nuclear reactor protective system.

Accordingly, in the safety injection tank system of the present invention, the safety valve that is mounted to the pressurizer is connected to the pressure equalization pipe, and so, when a low pressure safety injection tank is pressurized to a high pressure using the steam of the pressurizer, it is not required to separately control an on/off valve of the pressure equalization pipe.

Further, according to the present invention, it is not required to use electric power or a control signal when operating the on/off valve, and so the on/off valve can be reliably and efficiently operated even in the event of a nuclear power plant station blackout, and it is not required to install an additional dedicated battery that is configured to guarantee operation for at least 36 hours to 72 hours or more in the event of a nuclear power plant station blackout.

Further, the safety injection tank system according to the present invention is configured in such a way that, in the event of a small steam line break, the shutoff valve that is installed in a parallel state can be operated in response to a control signal of the nuclear reactor protective system or can be opened or closed by the remote manipulation of a pilot.

Further, the hybrid safety injection tank system pressurized with the safety valve of the pressurizer according to the present invention can be reliably and efficiently operated even in the event of a nuclear power plant station blackout, thereby remarkably improving the emergency core cooling capacity of a high pressure nuclear reactor system and realizing the safe operation of a nuclear reactor.

Hereinbelow, an embodiment of the hybrid safety injection tank system pressurized with the safety valve of the pressurizer according to the present invention will be described in detail with reference to the accompanying drawings.

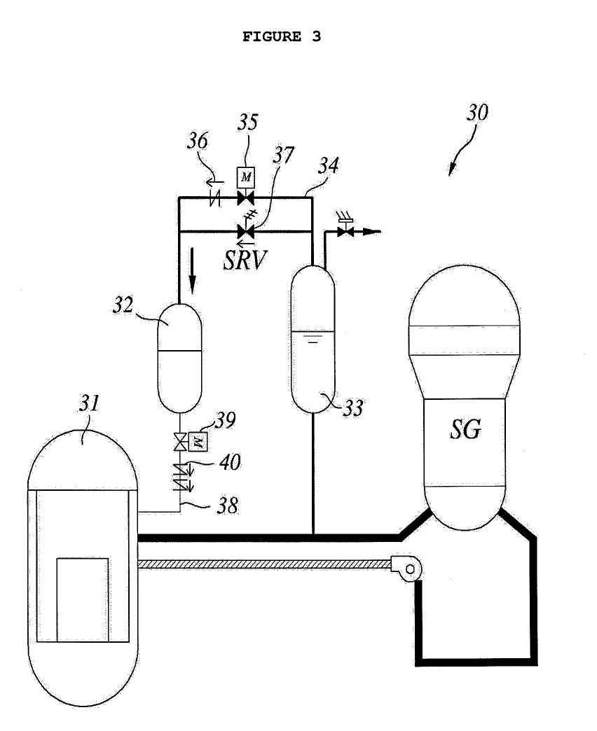

First, the hybrid safety injection tank system pressurized with the safety valve of the pressurizer according to the present invention will be described with reference to FIG. 3, which is a view schematically illustrating the construction of a hybrid safety injection tank system 30 according to an embodiment of the present invention.

Described in detail, the hybrid safety injection tank system 30 pressurized with the safety valve according to the embodiment of the present invention includes: a safety injection tank (SIT) 32 that supplies emergency core cooling water to a nuclear reactor system 31, a pressurizer 33 that supplies high pressure steam to the safety injection tank 32, a pressure equalization pipe 34 that connects the safety injection tank 32 to the pressurizer 33, a pressure equalization pipe isolation valve 35 that is installed on the pressure equalization pipe 34 so as to isolate the safety injection tank 32 from the pressurizer 33, a pressure equalization pipe check valve 36 that prevents a backflow from the safety injection tank 32 to the pressurizer 33, a safety valve 37 that is installed on the pressure equalization pipe 34 in such a way that the safety valve 37 is in parallel both with the isolation valve 35 and with the check valve 36, an emergency core cooling water injection pipe 38 that connects the safety injection tank 32 to the nuclear reactor system 31, a safety injection tank isolation valve 39 that is installed on the emergency core cooling water injection pipe 38 so as to isolate the safety injection tank 32 from the nuclear reactor system 31, and a check valve 40 that prevents a backflow from the nuclear reactor system 31 to the safety injection tank 32.

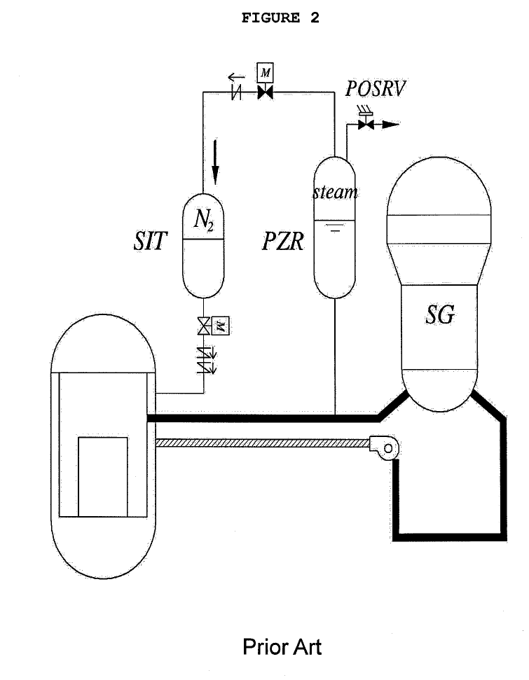

In other words, in the embodiment of the hybrid safety injection tank system 30 pressurized with the safety valve according to the present invention, the general construction that comprises the nuclear reactor system 31, the safety injection tank 32, the pressurizer 33, the pressure equalization pipe 34, the pressure equalization pipe isolation valve 35, the pressure equalization pipe check valve 36, the emergency core cooling water injection pipe 38, the safety injection tank isolation valve 39, and the cooling water check valve 40 remains the same as in the conventional hybrid safety injection tank system shown in FIG. 2. However, the construction of the embodiment of the present invention differs from the conventional hybrid safety injection tank system, as follows. That is, in the hybrid safety injection tank system 30 pressurized with the safety valve according to the present invention, the safety valve 37 that can be automatically opened or closed in response to a pressure without using separate electric power is installed on the pressure equalization pipe 34 in such a way that the safety valve 37 is in parallel both with the pressure equalization pipe isolation valve 35 and with the pressure equalization pipe check valve 36, as shown in FIG. 3.

For ease of description, the description of the elements common to both the conventional hybrid safety injection tank system and the present hybrid safety injection tank system will be omitted from the following description, but the different elements will be exclusively described.

As disclosed in Korean Patent No. 10-1071415, in a conventional hybrid safety injection tank system, a motorized valve or a pneumatic valve is installed on a pressure equalization pipe that realizes pressure equalization between the low pressure safety injection tank and the high pressure pressurizer of a safety injection tank system in which the function of a conventional low pressure safety injection tank (SIT) and the function of a conventional high pressure core makeup tank (CMT) are integrated with each other. Accordingly, it is required to necessarily install an additional dedicated battery in the conventional safety injection tank system so as to guarantee operation for at least 36 hours to 72 hours or more in the event of a nuclear power plant station blackout.

However, as shown in FIG. 3, in the hybrid safety injection tank system 30 pressurized with the safety valve according to the present invention, the safety valve 37 that can be automatically opened or closed in response to a pressure without using separate electric power or compressed air is added to the pressure equalization pipe 34 that connects the safety injection tank 32 to the pressurizer 33. Therefore, unlike in the conventional hybrid safety injection tank system, the hybrid safety injection tank system 30 of this invention can be reliably operated even in the event of a nuclear power plant station blackout without using the additional dedicated battery that was used in the conventional hybrid safety injection tank system so as to guarantee operation for at least 36 hours to 72 hours or more in the event of a nuclear power plant station blackout.

Described in detail, in the hybrid safety injection tank system 30 of the present invention, low pressure nitrogen gas (about 4.3 Mpa) and emergency core cooling water are charged in the safety injection tank (SIT) 32 that is connected to the nuclear reactor system 31 through the emergency core cooling water injection pipe 38, as shown in FIG. 3.

Further, high pressure steam is contained in the pressurizer (PZR) 33. Here, the upper part of the safety injection tank 32 is connected to the upper part of the pressurizer 33 by the pressure equalization pipe 34, and so pressure equalization between the high pressure pressurizer 33 and the low pressure safety injection tank 32 can be realized.

In other words, in a low pressure operation environment, the emergency core cooling water is injected into the nuclear reactor system 31 by the pressure of the nitrogen gas that is contained in the safety injection tank 32. On the contrary, in a high pressure operation environment in which the pressure of the nuclear reactor system 31 is increased over a predetermined critical pressure value, the pressure equalization pipe isolation valve 35 that is installed on the pressure equalization pipe 34 is opened so as to change the pressure of the safety injection tank 32 to a high pressure, and so the emergency core cooling water that is contained in the safety injection tank 32 can be injected into the high pressure nuclear reactor system 31.

Here, in the conventional hybrid safety injection tank system, the pressure equalization pipe isolation valve 35 may be, for example, a POSRV that can be opened or closed by a motorized valve or by a pilot. Further, providing against nuclear power plant station blackout in which electric power failure happens over a nuclear power plant, the valve of the conventional hybrid safety injection tank system should be configured to be opened or closed using power of an additional battery. Therefore, the conventional hybrid safety injection tank system is problematic in that in that, in addition to the first inconvenience, that the tank system should use an additional dedicated battery guaranteeing operation for at least 36 hours to 72 hours or more in the event of a nuclear power plant station blackout, the battery should be always maintained and managed to be in an available state in the event of emergencies, thus causing a secondary inconvenience.

However, unlike the conventional safety injection tank system, the hybrid safety injection tank system according to the present invention is configured such that the safety valve 37 that can be opened or closed in response to a pressure without using separate electric power or a separate driving device is installed in parallel with the pressure equalization pipe isolation valve 35, as shown in FIG. 3, instead of installation of an additional dedicated battery in the system, and so the present invention removes the inconvenience induced both by the installation of the battery and by the maintenance of the battery. Further, the hybrid safety injection tank system of this invention can be reliably and efficiently operated even in the event of a nuclear power plant station blackout.

In the present invention, the pressure-operated safety valve 37 is installed in the hybrid safety injection tank system, as described above, and so, when emergencies occur in the nuclear power plant and thus the pressure difference between the safety injection tank 32 and the pressurizer 33 rises so as to exceed a predetermined reference value of the safety valve 37, the safety valve 37 is automatically opened by the pressure, thereby realizing pressure equalization between the high pressure pressurizer 33 and the low pressure safety injection tank 32.

Further, as described above, when the safety valve 37 is automatically opened and, accordingly, when the pressure equalization pipe 34 is opened, the high pressure steam of the pressurizer 33 is injected into the low pressure safety injection tank 32, thereby pressurizing the safety injection tank 32. Accordingly, the pressure of the safety injection tank 32 is changed to a high pressure, and so the emergency core cooling water of the safety injection tank 32 can be injected into the high pressure nuclear reactor vessel.

Accordingly, in a low pressure operation of the hybrid safety injection tank system of this invention, the emergency core cooling water is injected into the nuclear reactor by the pressure of the nitrogen gas that is contained in the safety injection tank 32. On the contrary, in a high pressure operation of system, the pressure equalization pipe isolation valve 35 or the safety valve 37 of the pressure equalization pipe 34 is opened, and so the emergency core cooling water can be injected into the nuclear reactor. Accordingly, the hybrid safety injection tank system of this invention can be efficiently used in a low pressure or high pressure nuclear reactor system even in the event of a nuclear power plant station blackout.

As described above, the present invention can provide the hybrid safety injection tank system pressurized with the safety valve of the pressurizer.

In the present invention, the pressure equalization pipe is configured by connecting the motorized isolation valve that can be remote-controlled by a pilot to the pressure-operated safety valve in parallel with each other. Accordingly, when emergencies occur in which the nuclear reactor system is pressurized such that the pressure of the nuclear reactor system exceeds a predetermined reference pressure value of the pressurizer safety valve, the pressure equalization pipe can be opened by the safety valve. Further, when a high pressure accident occurs, in which the pressure of the nuclear reactor system rises over the predetermined reference pressure value of the safety valve, the motorized isolation valve can be opened by a remote control of a pilot or by a control signal of the nuclear reactor protective system. Accordingly, the present invention can remove a pressure difference between the nuclear reactor system and the safety injection tank system and can inject the emergency core cooling water into the nuclear reactor system.

Although a preferred embodiment of a hybrid safety injection tank system pressurized with a safety valve of a pressurizer according to the present invention has been described for illustrative purposes, those skilled in the art will appreciate that various modifications, additions and substitutions are possible, without departing from the scope and spirit of the invention as disclosed in the accompanying claims.

What is claimed is:

1. A hybrid safety injection tank system pressurized with a safety valve of a pressurizer, comprising:
an emergency core cooling water safety injection tank (SIT) charged both with cooling water and with nitrogen gas for cooling a nuclear reactor system;
a pressurizer for supplying high pressure steam to pressurize the safety injection tank;
a pressure equalization pipe connecting the safety injection tank to the pressurizer so as to realize pressure equalization between the safety injection tank and the pressurizer;
a pressure equalization pipe isolation valve installed on the pressure equalization pipe so as to isolate the safety injection tank from the pressurizer;
a pressure equalization pipe check valve installed on the pressure equalization pipe in series with the pressure equalization pipe isolation valve so as to prevent a backflow from the safety injection tank to the pressurizer; and
a safety valve installed on the pressure equalization pipe in parallel both with the pressure equalization pipe isolation valve and with the pressure equalization pipe check valve so as to isolate the safety injection tank from the pressurizer.

2. The hybrid safety injection tank system pressurized with the safety valve of the pressurizer as set forth in claim 1, further comprising:
an emergency core cooling water injection pipe connecting the safety injection tank to the nuclear reactor system;
a safety injection tank (SIT) isolation valve installed on the emergency core cooling water injection pipe between the safety injection tank and the nuclear reactor system; and
a cooling water check valve installed on the emergency core cooling water injection pipe in series with the safety injection tank isolation valve and configured to prevent a backflow from the nuclear reactor system to the safety injection tank.

3. The hybrid safety injection tank system pressurized with the safety valve of the pressurizer as set forth in claim 1, wherein the safety valve comprises a valve configured in such a way that the safety valve is automatically opened or closed in response to a pressure difference so as to be operated even in a nuclear power plant station blackout.

4. The hybrid safety injection tank system pressurized with the safety valve of the pressurizer as set forth in claim 3, wherein the safety valve is configured in such a way that the safety valve is opened when a pressure difference between the safety injection tank and the pressurizer exceeds a predetermined reference value.

5. The hybrid safety injection tank system pressurized with the safety valve of the pressurizer as set forth in claim 2, wherein each of the pressure equalization pipe isolation valve and the safety injection tank isolation valve is a valve that can be opened or closed by a remote manipulation of a pilot or by a control signal of a nuclear reactor control system.

6. The hybrid safety injection tank system pressurized with the safety valve of the pressurizer as set forth in claim 2, wherein each of the pressure equalization pipe isolation valve and the safety injection tank isolation valve is a motorized valve or a POSRV (pilot operated safety and relief valve) that can be opened or closed by a pilot.

7. A hybrid safety injection tank system comprising:
an emergency core cooling water safety injection tank (SIT) charged both with cooling water and with nitrogen gas;
a pressurizer configured to supply high pressure steam to the safety injection tank;
a pressure equalization pipe connecting the safety injection tank to the pressurizer;
a pressure equalization pipe isolation valve installed on the pressure equalization pipe between the safety injection tank and the pressurizer;
a pressure equalization pipe check valve installed on the pressure equalization pipe in series with the pressure equalization pipe isolation valve and configured to prevent a backflow from the safety injection tank to the pressurizer; and
a safety valve installed on the pressure equalization pipe in parallel both with the pressure equalization pipe isolation valve and with the pressure equalization pipe check valve and between the safety injection tank and the pressurizer.
